(19) United States
(12) Patent Application Publication
(10) Pub. No.: US 2008/0057586 A1
(43) Pub. Date: Mar. 6, 2008

(54) Fluorescent Cartridge for Calibration of a Microarray Reader

(76) Inventors: James P. Light, San Diego, CA (US); Kenny V. Nguyen, San Diego, CA (US)

Correspondence Address: O''Melveny & Myers LLP;IP&T Calendar Department LA-1118, 400 South Hope Street, Los Angeles, CA, 90071-2899, US

(21) Appl. No.: 11/847,991

(22) Filed: Aug. 30, 2007

Related U.S. Application Data
(60) Provisional application No. 60/842,239, filed on Sep. 5, 2006.

(51) Int. Cl. G01N 31/00

(52) U.S. Cl. 436/8

(57) ABSTRACT

An optically clear, fluorescent acrylic adapted for use as a calibration material. In particular, the fluorescent acrylic cartridge may used as a calibration tool for a microarray reader, such as, the Nanogen NC400® microarray system.

### RELATED APPLICATIONS

This patent application claims the priority benefit of U.S. Provisional Application Ser. No. 60/841,781, filed Sep. 5, 2006, the specification of which is incorporated herein by reference in its entirety.

### FIELD OF THE INVENTION

The present invention is directed to an optically clear, fluorescent acrylic adapted for use as a calibration material. More specifically, the invention is directed to a fluorescent acrylic cartridge used as a calibration tool for a microarray reader, such as, for example, the Nanogen NC400® microarray system.

### BACKGROUND OF THE INVENTION

Several instruments use light to detect, for example, the presence or absence of a bound, labeled probe. Typically, these instruments act by measuring absorbance such that light is passed through the sample and the wavelength or intensity of the beam is recorded by a detector. Other instruments operate by measuring luminescence such that any light emitted from the sample is monitored by a detector. One example of a microarray reader particularly well-suited for use with the present invention is the Nanogen NC400® microarray system, which is described generally in U.S. Pat. No. 5,605,662 and which is incorporated herein by reference.

In order to properly calibrate the response of a microarray reader, it is desirable to use a dry, stable and uniformly fluorescent material. Calibration is necessary to ensure that the analysis conducted on the microarray and reported by the microarray reader is reproducible and accurate. Calibration can correct systemic instrument errors, thereby facilitating comparison of results across different measurements taken on the same instrument at different times, as well as measurements taken on different instruments. In addition, calibration is useful to convert raw measured signals into absolute calibrated measurements.

There is a need for a calibration standard that can be easily incorporated into a microarray reader to allow proper calibration of the machine. In particular, there is a need for an optically clear acrylic having a uniform distribution of red and green fluorescent dyes.

### SUMMARY OF THE INVENTION

The present invention relates to compositions and methods for calibrating instruments that measure light in order to provide a result to the user. Particularly, the present invention relates to fluorescent cartridges useful in calibrating microarray readers, such as, for example, the Nanogen NC400 microarray system. The fluorescent cartridges are particularly useful not only because they made are fabricated from durable acrylic, but also because the user-selected fluorescent dyes are uniformly distributed throughout the acrylic media.

In one embodiment, the invention provides a microarray calibration composition comprising an acrylic polymer into which are incorporated a first and second fluorescent dyes. In certain embodiments, one dye is “red” and the other dye is “green.” As used herein, “red” dyes emit light in the range near 600-630 nm. Similarly, as used herein, “green” dyes emit light in the range near 550-580 nm. Typically, the fluorescent dyes are present in the acrylic polymer in amounts required to achieve desired signals. The precise ratio of the dyes (equimolar in some instances; non-equimolar in other instances) will vary depending on the particular application. In some embodiments, the red dye may be, for example, Cy5, Bothell red, or Quasar 670 carboxy acid, while the green dye may be, for example, Cy3. In other embodiments, the acrylic polymer is poly methyl methacrylate (“PMMA”). In still other embodiments, three or more fluorescent dyes are incorporated into the acrylic polymer. Dyes of different “color” may be used in nearly any combination, limited only by the needs of the user and the resolving power of the instrument in need of calibration. Many different types of instruments have the ability to “read” and process different wavelengths of light. Automated DNA sequencers are just one example.

In another embodiment, the present invention provides a method for calibrating a microarray reader by following the steps of preparing a fluorescent acrylic calibration composition having a first and second fluorescent dye; placing the fluorescent acrylic calibration composition in the microarray reader that includes an excitation source and a detector; directing the excitation source at the calibration composition; detecting a value for a feature of the light (e.g., relative fluorescent unites, intensity, or wavelength) being emitted from a pre-determined position on the calibration composition; and comparing the detected value of the feature of the light being emitted from the pre-determined position on the calibration composition in an instrument being calibrated to the detected value of the feature of light being emitted from the pre-determined position on the calibration composition in a reference instrument. In other embodiments, the acrylic calibration composition may contain three or more fluorescent dyes.

### BRIEF DESCRIPTION OF THE DRAWINGS

FIG. 1 is a graphical depiction demonstrating the stability of the fluorescent dyes as tested by exposure to LED light in the ranges of between about 470-510 nm and about 600-630 nm.

FIG. 2 is a graphical depiction demonstrating the average signal intensity of four separate cartridges.

### DETAILED DESCRIPTION OF THE INVENTION

The calibration composition and related methodologies of the present invention allow important molecular biology and molecular diagnostic reactions to be carried out with increased accuracy and precision. Although the present invention is described with reference to the Nanogen® 400 Chip System, it may be used generally in any application requiring calibration of fluorescent response.

The NanoChip® 400 site electronic microarray cartridges are ideal for the development of multiplexed tests. Multiple samples can be applied to the same array and each cartridge may be reused until all tests sites have been utilized. The NanoChip® 400 system has numerous advantages, including, for example, each test site can detect multiple targets to enhance multiplexing; Electronic control ensures sample fidelity at each test site; multiplexed results are easy to interpret through data analysis software.

In the second generation NanoChip® Electronic Microarray, enhancements have been made to improve thermal discrimination, assay stringency and cartridge life. The cartridge can be utilized several times until all 400 test sites are used. This reusability makes the NanoChip® 400 cartridge easier and more cost-effective to use than research-grade, thousand-gene chip arrays. And the multiplex capability of the cartridge makes it more suitable than polymerase chain reaction (PCR) when multi-allele or multi-gene assays are of interest.

The NanoChip® microarray technology provides an open platform that allows customers to easily run common assays, as well as customize their own assays. In particular, microarray readers are useful in conducting, among others, DNA and RNA assays, detecting single nucleotide polymorphisms (SNPs), short tandem repeats (STRs), insertions, deletions and other mutation analyses.

In short, the NanoChip® platform allows electronic addressing, in which one or more test sites are activated with positive charge, biotinylated samples or probes are bound to streptavidin permeation layer on the chip at those sites and activated test sites are turned off, allowing for reporting. For reporting functions, red and green fluorescently-labeled probes or samples are hybridized to bound complementary biotinylated strands. Then, the NanoChip® systems scan the chip and automatically analyze red and green fluorescent ratios to determine results.

An important aspect of accurate and precise reporting is proper calibration. The compositions and methodologies described in the examples below are particularly well-suited for facile calibrations.

All patents, patent applications, and published patent applications, and other publications referred to herein are hereby incorporated herein in their entirety by reference, as if they were fully reproduced herein.

### EXAMPLES

The invention will now be described in greater detail by reference to the following non-limiting examples regarding the production and use of fluorescent calibration cartridges for use in microarray readers.

### Example 1

In this example, compositions of poly methyl methacrylate (“PMMA”) containing fluorophores were fabricated. These experiments show that either heat or photochemical initiation could be used to polymerize a mixture of methyl methacrylate monomer, fluorescent dye, and free-radical initiator, into an acrylic sheet containing active dye. First, a fluorescent MMA solution having 0.02% UV or heat initiator was made using the following protocol. A 0.2% initiator solution was made by dissolving Darocur 4265 or Azobis Isobutylnitrile in DMSO. A solution of 100 μM Cy3 and Cy5 analog fluorescent dyes were added to DMSO. The final monomer containing the fluorescent dyes and initiator were synthesized according to the ratios shown in the table below. The final solution had 0.02% initiator and 100 nM each of the fluorescent dyes. The resulting 2 ml volume of solution was sufficient enough to make one 2″×3″×0.04″ PMMA slice.

| MMA | | 100 μM Cy3 | 100 μM Cy5 | |
|---|---|---|---|---|
| solution | Initiator | dye in DMSO | dye in DMSO | Total volume |
| (μl) | solution (μl) | (μl) | (μl) | (μl) |
| 1796 | 200 | 2 | 2 | 2000 |

Second, a glass mold was prepared. Glass and nylon strips were cleaned with soap and water. The glass was then soaked in acetone for a few seconds and dried with a tissue. Glass was subsequently soaked in ethanol for a few seconds, dried with a tissue followed by nitrogen. A solution of Rain-X™ was applied to the clean, dried glass and allowed to dry for 15 minutes. Any residual Rain-X™ was removed with ethanol and a tissue. The mold was set up by binding the nylon strips between pieces of glass and held in place with binder clips. The edges were sealed with a 1% agarose solution to prevent the MMA solution from leaking. The monomer solution was pipetted into the glass mold.

Third, the MMA solution was polymerized by exposure to UV. The mold was placed in front of a UV lamp set to emit a wavelength of 365 nm for 1 hour. Alternatively, the MMA solutions could be cured with heat by placing the mold in an incubator at 70° C.-75° C. for 1 hour.

Additionally, the glass mold can be made using glass microscope slides. Finally, fluorescent compositions were also made with Cy5 analogs (1,1′,3,3,3′,3′-hexamethylindodicarbocyanine iodide) and Cy3 analogs (1,1′-diethyle-3,3,3′,3′-tetramethylindocarbocyanine iodide), which homogeneously dissolve in MMA.

It should be noted that there are many combinations of fluorescent dyes available for use with the present invention and for multi-channel applications. In choosing particular dyes, those of sill in the art will recognize that the importance of choosing emission spectra that are sufficiently different or resolvable so that the amount of the different dyes can be measured by the instrument's optics system. ABI products for real-time PCR and sequencers are suitable examples. In that system, five different dyes may be used for simultaneous detection in PCR. Moreover, it is routine for automatic sequencers to utilize four colors.

### Example 2

In this example, fluorescent PMMA cartridges were fabricated and the stability of the fluorescent dyes was tested by exposure to LED light in the ranges of between about 470-510 nm and about 600-630 nm. This experiment demonstrated different methods of treating the acrylic and assembling the acrylic into a format suitable for use in a micro-array reader. The experiment also showed that the dyes in the acrylic were sufficiently resistant to photo-bleaching, thereby enabling a stable calibration device to be made from the acrylic.

First, the fluorescent MMA solution was prepared. Specifically, an initiator solution of 0.4% (w/v) was prepared by dissolving 352 mg Darocur 4265 in 880 μl DMSO. A 100 μM solution of Cy3 and Cy5 dyes were prepared. The final monomer solution was mixed according to the concentrations shown in the table below. The finial monomer solution contained 0.04% initiator and 100 nM of each fluorescent dye. The 8 ml volume of final mixture was sufficient to make five 2″×3″×0.04″ PMMA slices.

| MMA | | 100 μM Cy3 | 100 μM Cy5 | |
|---|---|---|---|---|
| solution | Initiator | dye in DMSO | dye in DMSO | Total volume |
| (μl) | solution (μl) | (μl) | (μl) | (μl) |
| 7148 | 800 | 8 | 8 | 8000 |

Second, the glass molds were prepared as described in Example 1. The monomer mixture was pipetted into the molds and polymerized under UV light for 1 hour. After curing, the PMMA slices were cut into small pieces with a razor blade before assembly into the cartridges.

Some of the PMMA pieces were clamped between two ¼″ thick glass slices and annealed at 100° C. for 2 hours. Annealing may be used to reduce internal stresses of PMMA that result from polymerization. There was no significant difference noted between fluorescent PMMA compositions fabricated with or without the annealing step. PMMA compositions that were cured for 1 hour under UV light appeared to be more completely polymerized and stable than those that were cured for 30 minutes.

A summary of the properties of the assembled cartridges is shown in the table below.

| | Fluorophore | | |
|---|---|---|---|
| | Concentration | | |
| Index | (nM) | Backing Material | Curing Conditions |
| 1 | 200 | Chip | 0.5 hours with UV |
| 2 | 200 | Black Alumina | 0.5 hours with UV |
| 3 | 200 | Black Vinyl | 0.5 hours with UV |
| 4 | 250 | Chip | 0.5 hours with UV |
| 5 | 250 | Black Alumina | 0.5 hours with UV |
| 6 | 250 | Black Vinyl | 0.5 hours with UV |
| 7 | 100 | Black Vinyl | 1.0 hour with UV |
| 8 | 100 | Black Vinyl | 1.0 hour with UV |
| 9 | 100 | Black Vinyl | 1.0 hour with UV |
| 10 | 100 | Black Vinyl | 1.0 hour with UV |
| 11 | 100 | Black Vinyl | 1.0 hour with UV |
| 12 | 100 | Black Vinyl | 1.0 hour with UV; |
| | | | heated overnight at |
| | | | 100° C. |
| 13 | 100 | Black Vinyl | 1.0 hour with UV; |
| | | | heated overnight at |
| | | | 100° C. |
| 14 | 100 | Black Vinyl | 1.0 hour with UV; |
| | | | heated overnight at |
| | | | 100° C. |
| 15 | 100 | Black Vinyl | 1.0 hour with UV; |
| | | | heated overnight at |
| | | | 100° C. |
| 16 | 100 | Black Vinyl | 1.0 hour with UV; |
| | | | heated overnight at |
| | | | 100° C. |

Cartridges 14 and 17 had PMMA that were heated at 100® C. overnight to anneal. The result was PMMA that was thinner exhibiting lower fluorescent signals.

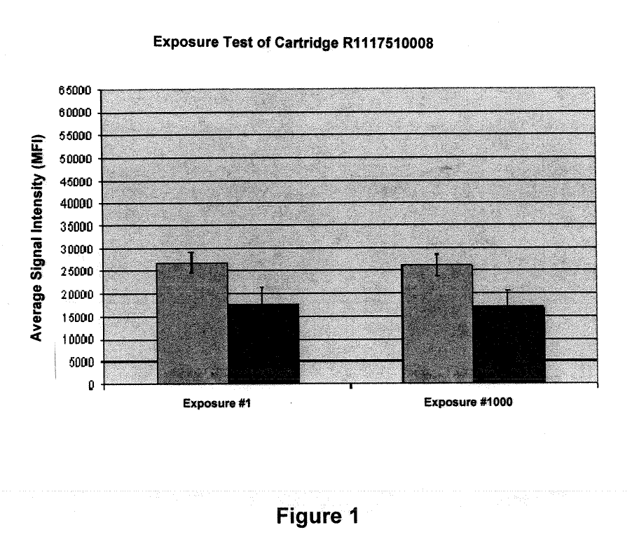

In general, the fluorescent signals varied with the different backing materials. Typically, fluorescent PMMA with black vinyl backing provided the lowest signal intensity among those backing materials tested. Photo-bleaching of fluorescent dyes upon multiple exposures is a common problem in fluorescent micro array technology. The acrylic in cartridge #7 was assembled into a cartridge designed to be used with the NanoChip® 400 electronic micro array instrument. It was subjected to 1000 images with only a 4% change in the fluorescent intensity, as shown in FIG. 1. The results demonstrated the stability achieved when the dyes were incorporated into a solid-state substrate.

### Example 3

In this example, the reproducibility of the fluorescent acrylic assembled into fluorescent cartridges designed for the NanoChip 400® instrument was tested. First, the fluorescent acrylic slices were fabricated using the following protocol. A 6% Darocur in MMA solution was made by dissolving 1.004 g Darocur 4265 in 16.727 ml MMA. The final mixture was prepared according to the specification shown in the table below.

| MMA with 6% | 100 μM Cy3 dye | 100 μM Cy5 dye | Total volume |
|---|---|---|---|
| Darocur (ml) | in DMSO (μl) | in DMSO (μl) | (ml) |
| 14.970 | 15 | 15 | 15.000 |

The resulting acrylic slices were cured with UV for 1 hour. The glass molds containing the cured PMMA were soaked in warm water for 15 minutes prior to separation of the PMMA from the glass.

Second, the cartridges were assembled. The PMMA slices were cut with a razor bald into small pieces about 13 mm². Black vinyl backing adhesive was applied to the bottom surface of the acrylic pieces. Two thin strips of pressure-sensitive adhesive were applied to the top surface on opposite edges. The top side of the acrylic was attached to the flow cell, and the acrylic was aligned at the center of the flow cell so that the adhesive strips were parallel with the fluidic channels. A small amount of Norland 65 was placed along the top and bottom edges and cured with UV for 90 seconds. The pressure-sensitive adhesive was used to hold the chip in place before a permanent bond was achieved with Norland 65. Finally, the flow cell was snapped into place in the cartridge body.

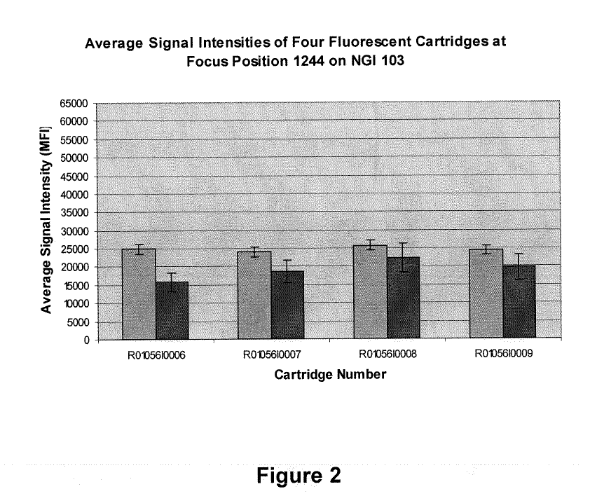

Third, the assembled cartridge was scanned and inserted into the instrument for an imaging test. The results of the tests are shown in FIG. 2.

### Example 4

In this example, the production of the fluorescent acrylic as larger sheets that could be cut into multiple pieces suitable for use in a micro array reader was refined. First, the glass molds were prepared using the following protocol. Glass plates and silicon gaskets were cleaned with soap and water, rinsed with deionized water, and dried with tissues. Clean glass plates were subsequently treated with Rain-X™ solution and allowed to dry. Two glass plates were assembled with a 0.04″ silicon gasket inserted between the panels.

Second, the fluorescent acrylic monomer solution was prepared. A 6% solution of UV initiator in monomer was prepared by dissolving 275 mg Darocur 4265 in 45.8 ml of MMA. The final monomer solution had the characteristic described in the chart below.

| MMA with 6% | 100 μM Cy3 dye | 100 μM Cy5 dye | Total volume |
|---|---|---|---|
| Darocur (ml) | in DMSO (μl) | in DMSO (μl) | (ml) |
| 39.9 | 40 | 40 | 40.0 |

Finally, the cured acrylic was polymerized and processed using the following procedure. The glass mold was filled with the final mixture containing MMA and dyes to the top of the gasket. The mold was placed 10 inches from the 15 W UV (365 nm) black light for 16 hours to cure. The volume of the acrylic typically shrinks during polymerization. Rapid polymerization rates may lead to formation of bubbles, diffraction lines and other defects. After the polymerization was complete, the mold was submerged in 60° C. water for 5 minutes and placed in 20° C. deionized water before gentle separation of the acrylic from the glass.

The fluorescent acrylic was rinsed with deionized water again and allowed to dry, protected from light, then stored at ambient temperature, also in the dark.

### Example 5

In this example, the suitability of different dyes to make stable fluorescent acrylic was examined. Fluorescent acrylic cartridges were fabricated. Each cartridge had three different red fluorescent dyes: Bothell Fluor 414, Quasar 670 carboxy acid, and Hilyte Fluor 647 acid, SE. After fabrication, the cartridges were tested for signal intensity and integration linearity on NanoChip® 400 instruments.

First, the dyes were prepared. The Bothell Fluor 414 (lot AV797-044 Nanogen, Inc.; MW 1509.18) dye was prepared. by dissolving 0.8 mg in 0.533 ml DMSO to provide a concentrated stock solution of 1 mM. A 100 μM dilution was made by mixing 20 μl of the stock solution into 180 μL of DMSO. Similarly, a stock solution of Quasar 670 (Biosearch Technologies; MW 497.69) carboxy acid dye was prepared by adding 1 ml DMSO to 10 mg of solid dye to yield a 20 mM solution. Subsequently, 5 μl of the stock solution was mixed with 995 μl of DMSO to provide a 100 μM solution. Finally, the Hilyte 647 acid SE (AnaSpec, PN: 81256; MW 1302.71) stock solution was prepared by adding 1 ml DMSO to 1 mg of dye to make a 0.7 mM solution. The working solution was prepared by adding 142.86 μl of the stock solution into 857.14% DMSO to make a 100 μM solution.

Second, the fluorescent acrylic monomer solutions were prepared according to the specifications in the table below.

| | | | Volume of | | |
|---|---|---|---|---|---|
| | Weight of | | 100 μM Cy3 | Volume of | Total |
| | Darocur | Volume of | dye in | red dye in | volume |
| Dye | 4265 (mg) | MMA (ml) | DMSO (μl) | DMSO (μl) | (ml) |
| Bothell | 151.5 | 25.25 | 25.45 | 25.45 | 25.45 |
| Quasar | 150.7 | 25.12 | 25.32 | 25.32 | 25.32 |
| Hilyte | 154.7 | 25.78 | 25.99 | 25.99 | 25.99 |

The glass molds were prepared as described in Example 1. The glass molds were filled with the final mixture containing MMA and dyes to the top of the gasket. The molds were cured by placement at 15 inches from 15 W UV (365 nm) black light for 16 hours. The molds were moved to within 6 inches of the light source to fully cure for an additional 2 hours. When the polymerization was complete, the molds were submerged in 60° C. water from 5 minutes, then placed in 20° C. deionized water before being gently separated from the glass. The fluorescent acrylic was rinsed with deionized water and dried, protected from light. Fluorescent acrylics were stored at ambient temperature in the dark.

Third, cartridges were assembled. The fluorescent acrylic sheets were cut into 225 mm² (15 mm×15 mm) pieces and assembled as described above in Example 1.

Two fluorescent cartridges were assembled from each lot and read on a NanoChip® 400 instrument for fluorescent signals. The linear response of fluorescent signal intensity was compared to integration times of four fluorescent cartridges containing four different red fluorescent dyes. The Cy5 and Bothel Fluor 414 dyes gave similar signal intensities, the Quasar 670 dye gave about 30% intensity compared to Cy5 and Bothell Fluor 414, and the Hilyte 647 gave no appreciable red fluorescence signal. The Hilyte 647 dye did fluoresce when dissolved in histidine buffer, consistent with observations that the dye fluoresces in polar environments but not in apolar environments, such as PMMA. In separate photo-bleaching stability experiments, Bothell Fluor 414 dye exhibited at least a two-fold less degradation for the same exposure time than the Cy5 dye in this application.

Modifications and other embodiments of the invention will be apparent to those skilled in the art to which this invention relates having the benefit of the foregoing teachings, descriptions, and associated drawings. The present invention is therefore not to be limited to the specific embodiments disclosed but is to include modifications and other embodiments which are within the scope of the appended claims. All references are herein incorporated by reference.

We claim:

1. A microarray calibration composition comprising:
an acrylic polymer;
a first fluorescent dye; and
a second fluorescent dye.

2. The microarray calibration composition of claim 1 further comprising at least a third fluorescent dye.

3. The microarray calibration composition of claim 1, wherein the first and second fluorescent dyes are present in substantially equimolar ratios.

4. The microarray calibration composition of claim 3, wherein the first fluorescent dye is selected from the group consisting of Cy5, Bothell red, and Quasar 670 carboxy acid, and the second fluorescent dye is Cy3.

5. The microarray calibration composition of claim 1, wherein the first and second fluorescent dyes are present in substantially non-equimolar ratios.

6. The microarray calibration composition of claim 5, wherein the first fluorescent dye is selected from the group consisting of Cy5, Bothell red, and Quasar 670 carboxy acid, and the second fluorescent dye is Cy3.

7. The microarray calibration composition of claim 1, wherein the acrylic polymer is PMMA.

8. A method for calibrating a microarray reader comprising the steps of:
preparing a fluorescent acrylic calibration composition having at least a first and second fluorescent dye;
placing the fluorescent acrylic calibration composition in the microarray reader, wherein the microarray reader includes an excitation source and a detector;
directing the excitation source at the calibration composition;
detecting a value for a feature of the light being emitted from a pre-determined position on the calibration composition; and
comparing the detected value of the feature of the light being emitted from the pre-determined position on the calibration composition in an instrument being calibrated to the detected value of the feature of the light being emitted from the pre-determined position on the calibration composition in a reference instrument.

9. The method of claim 8, wherein the feature of light is selected from the group consisting of relative fluorescent units, intensity, and wavelength.

10. The method of claim 8, wherein the fluorescent acrylic calibration composition further comprises a first red dye is selected from the group consisting of Cy5, Bothell red, and Quasar 670 carboxy acid, and a second green dye.

11. The method of claim 8, wherein the fluorescent acrylic calibration composition further comprises at least a third fluorescent dye.

12. The method of claim 8, wherein the first and second fluorescent dyes are present in the calibration composition in substantially equimolar ratios.

13. The method of claim 8, wherein the first and second fluorescent dyes are present in the calibration composition in substantially non-equimolar ratios.
